(19) United States
(12) Patent Application Publication
(10) Pub. No.: US 2004/0042768 A1
(43) Pub. Date: Mar. 4, 2004

(54) Apparatus and control method for recording and reproducing audio-video data

(76) Inventor: Jun Momose, Tokyo (JP)

Correspondence Address: ROBERT J. DEPKE LEWIS T. STEADMAN, HOLLAND & KNIGHT LLC, 131 SOUTH DEARBORN, 30TH FLOOR, CHICAGO, IL, 60603, US

(21) Appl. No.: 10/631,631

(22) Filed: Jul. 31, 2003

(30) Foreign Application Priority Data
Aug. 28, 2002 (JP) P2002-249660

(51) Int. Cl. H04N 5/781

(52) U.S. Cl. 386/111; 386/125

(57) ABSTRACT

An audio-video recording and reproducing apparatus equipped with a hard disk drive is provided, which is capable of reproducing audio-video data recorded in its HDD and reducing the power consumption significantly while keeping a stable data reproduction. Since data transfer rates from a HDD to a buffer memory are high enough than data transfer rates from a buffer memory to a reproduction section, there is a time period in which the data transfer from the HDD to the buffer memory can be stopped during the data reproduction. Taking advantage of such time period, the HDD is put into the dormancy state, and the CPU controlling a data transfer from the HDD to the buffer memory is put into a dormant state simultaneously. Therefore, the HDD and the CPU are put into a dormant state intermittently during the data reproduction, thus an average power consumption can be reduced.

### CROSS REFERENCE TO RELATED APPLICATIONS

The present document is based on Japanese Priority Document JP2002-249660, filed in the Japanese Patent Office on Aug. 28, 2002, the entire contents of which being incorporated herein by reference.

### DETAILED DESCRIPTION OF THE INVENTION

1. Field of the Invention

The present invention relates to an audio-video recording and reproducing apparatus equipped with a hard disk drive therein, which is capable of recording audio-video data transferred from outside to its hard disk drive, reading and reproducing the recorded data with an arbitrary timing, and relates to its control method.

2. Description of the Related Art

In recent years, as a storage of an audio-video recording and reproducing apparatus capable of recording and reproducing audio-video data for home use, a hard disk drive (hereinafter referred to as a “HDD”) that has a large capacity with inexpensive bit unit cost and enables random access is adopted.

Currently, a stationary type audio-video recording and reproducing apparatus employing a HDD with a 3.5-inch diameter medium is becoming widely used. This is known as a HDD recorder for recording TV broadcast programs.

Other than the HDD using a 3.5-inch diameter medium, there are HDDs using more compact and lighter medium such as 2.5-inch diameter medium, 1.8-inch diameter medium, or 1.0-inch diameter medium, and they are becoming increasing popular in late years. Along with the popularization of such small HDDs, widespread use of a portable audio-video recording and reproducing apparatus (mobile type) is being eagerly anticipated.

The mobile type audio-video recording and reproducing apparatus equipped with such a small HDD is able to offer new pleasures to a user, for example, a user can watch and enjoy a program whenever the user wishes if only downloading to its small HDD a program which is recorded by a stationary type HDD recorder mentioned earlier. For example, a user can watch TV programs, such as a drama or a morning news show, recorded by the HDD recorder even on the way to his/her office.

Furthermore, in such mobile type audio-video recording and reproducing apparatus, the longer a battery operating time becomes, the more drastic an improvement can be expected with respect to the convenience thereof.

### SUMMARY OF THE INVENTION

A HDD consumes large power as compared with a nonvolatile memory like a flash memory because the HDD has mechanical drive units such as a spindle motor for moving an arm and a voice coil motor for driving media.

For this reason, a technology is desired that realizes to reduce power consumption of a HDD without sacrificing a function of a mobile type apparatus that is premised on using a battery. As a power saving technology for a HDD, for a personal computer, a technology is known such that a HDD is put into a predetermined dormant state (sleep mode) during the period of not a HDD being used. That is, for example, electricity to a HDD is cut if no event from outside is detected for more than a predetermined period.

Using such a power saving technology, the same power saving effect as for a personal computer can be expected for the mobile type audio-video recording reproducing apparatus. However, since the audio-video recording and reproducing apparatus is dedicated in applications to record and reproduce audio-video data, a long idle period does not occur frequently like a personal computer does. Thus, in practice, the highly power saving effect cannot be obtained. In addition, there is a limitation in the power reduction if only the HDD is taken into consideration.

In order to solve such inconvenience, the present invention provides an audio-video recording and reproducing apparatus which is capable of reducing power consumption significantly while keeping stable data reproduction, and also provides its control method.

To satisfy the needs described above, the present invention provides an audio-video recording and reproducing apparatus including: a hard disk drive for storing audio and/or video data, which is capable of being one of a dormant state and an active state; a buffer memory for temporarily storing data read from the hard disk drive; a system controller for performing at least data transfer from the hard disk drive to the buffer memory and switching control of the state of the hard disk drive, which is capable of being one of a dormant state and an active state; a reproducing section for reproducing data read from the buffer memory; and a memory controller having a function for outputting a signal for setting respective states of the hard disk drive and the system controller based on an effective data volume of the buffer memory.

A data transfer rate from a hard disk drive to a buffer memory is higher than a data transfer rate from the buffer memory to a reproduction section. Therefore, during a data reproduction period, there is a time period in which the data reproduction is not hindered even if the data transfer from the hard disk drive to the buffer memory is stopped.

Taking advantage of such time period, in the present invention, the hard disk drive is put into a dormant state and also a system controller for controlling data transfer from the hard disk drive to the buffer memory is put into the dormant state simultaneously. In this way, the hard disk drive and the system controller are in the dormant state intermittently during the data reproduction period, thus average power consumption can be reduced.

Specifically, based on an effective data volume of the buffer memory during the data reproduction, it is possible to determine the time period in which data transfer from the hard disk drive to the buffer memory may be stopped.

More specifically, the memory controller may be configured to output a signal to the system controller so as to put the system controller and the hard disk drive into the dormant state when the data volume of the buffer memory becomes full of its capacity, and to output a signal to the system controller so as to release the system controller and the hard disk drive from the dormant state when the data volume of the buffer memory becomes equal to or less than a threshold level.

Moreover, in the present invention, the reproduction section may include a decoder for decompressing/decoding the compressed encoded audio-video data.

There is large enough difference between data transfer rates from the hard disk drive to the buffer memory and a decode bit rate of data, so that the system controller and the hard disk drive may be stopped for a certain period during the data reproduction. Therefore, even though accounting a necessary time for starting up the hard disk drive, or the like, a dormant time for the hard disk drive can be secured.

Furthermore, in the present invention, the memory controller and the reproduction section have functions to autonomously execute a set of process starting from the reading of data from the buffer memory to the reproducing of data, and they do not depend on control of the system controller.

Accordingly, data reproduction is assured for the period when the system controller is in the dormant state.

Further, in order to satisfy the needs described above, the present invention also provides a method for controlling an audio-video recording and reproducing apparatus including the steps of: transferring audio and/or video data read from a hard disk drive capable of being one of a dormant state and an active state to a buffer memory, under control of a system controller capable of being one of a dormant state and an active state; and reproducing data read from the buffer memory; switching respective states of the system controller and the hard disk drive based on an effective data volume of the buffer memory, which is monitored during a data reproduction.

According to the above, in the same way as the apparatus of the present invention, the time period, in which the data transfer from the hard disk drive to the buffer memory may be stopped, is determined by monitoring the effective data volume of the buffer memory during the data reproduction, and the hard disk drive and the system controller are put into the dormant state. By putting the hard disk drive and the system controller into the dormant state intermittently during the data reproduction, an average power consumption may be reduced.

### BRIEF DESCRIPTION OF THE DRAWINGS

FIG. 1 is a hardware block diagram which shows an embodiment in case where the present invention is applied to a mobile type audio-video recording reproducing apparatus;

FIG. 2 is a diagram explaining an address management of a DRAM by the memory controller shown in FIG. 1;

FIG. 3 is diagram showing a full status of the DRAM in the address management of the DRAM shown in FIG. 2;

FIG. 4 is a diagram showing a status equal to or less than a threshold level of the DRAM in the address management of the DRAM showing in FIG. 2; and

FIG. 5 is a flowchart showing a flow of switching action modes of a HDD and a CPU during data reproduction.

### DESCRIPTION OF THE PREFERRED EMBODIMENT(S)

Referring to accompanying drawings, an embodiment of the present invention will be described as follows.

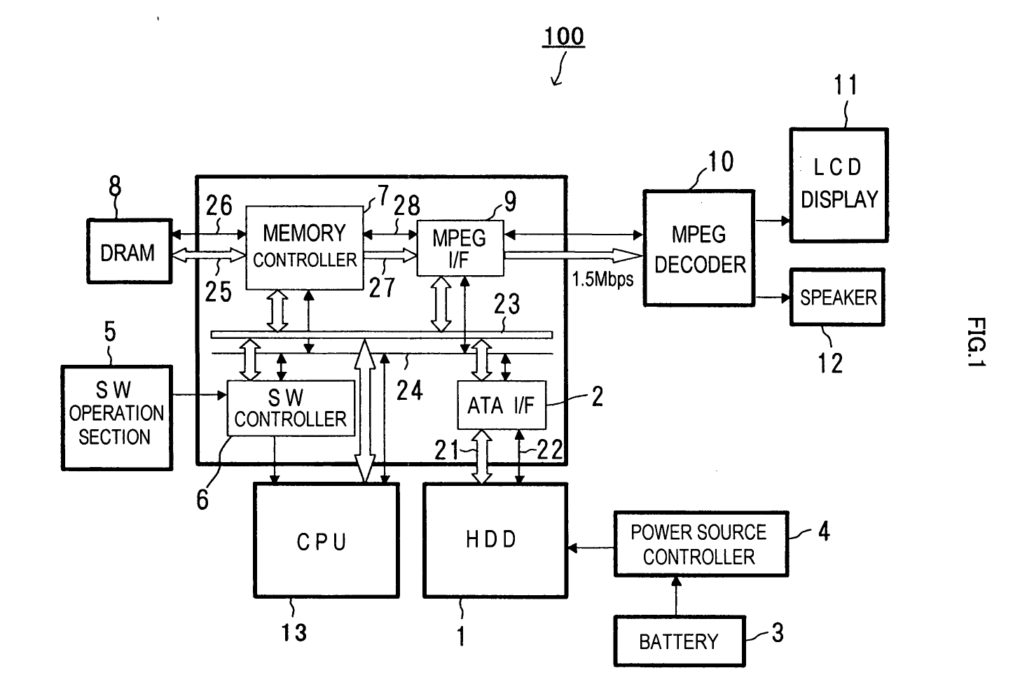

FIG. 1 is a hardware block diagram that shows an embodiment in case where the present invention is applied to a mobile type audio-video recording reproducing apparatus 100.

As shown in the figure, the audio-video recording and reproducing apparatus 100 has a hard disk drive 1 (hereinafter, it is referred to as a HDD 1), an ATA (AT attachment) interface 2, a battery 3, a power source controller 4, a SW (switch) operation section 5, a SW controller 6, a memory controller 7, a DRAM 8 (Dynamic Random Access Memory) used as a buffer memory, a MPEG (Moving Picture Coding Experts Group) interface 9, a MPEG decoder 10, a LCD (Liquid Crystal Display) display 11, a speaker 12 and a CPU 13 (Central Processing Unit) served as a system controller.

The HDD 1 and the ATA interface 2 are connected to each other with, for example, a data line 21 of 2 bytes width and a control line 22, such as CS, DA, DIOR/DIOW, IORDY, to realize transfer with a PIO (Programmed Input/Output) mode.

The CPU 13 and the SW controller 6, the memory controller 7 and the MPEG interface 9 are respectively connected to each other with, for example, a data line 23 of 4 bytes width and a control line 24 needed to carry out accessing to a register, such as CS*, R/W, RD, ADDR, WAIT.

The DRAM 8 and the memory controller 7 are connected to each other with, for example, a data line 25 of 2 bytes width and a control line 26 such as RAS, CAS, WE, CS, CKE.

The memory controller 7 and the MPEG interface 9 are connected to each other, for example, with a data line 27 of 4 bytes width and a control line 28 of a read data requesting signal (RD_REQ) from the MPEG interface 9 and of (RD_VAL) signal outputted from the memory controller 7 at the time of data is secured.

In the HDD 1, for example, audio-video data transferred from outside is accumulated. The audio-video data read from the HDD 1 by the CPU 13 is written to the DRAM 8 through the memory controller 7. A capacity of the DRAM 8 is, for example, 16 MB (megabytes) or 32 MB.

The memory controller 7 enables high-speed data transfer from the HDD 1 to the DRAM 8 by a burst writing to the DRAM 8.

The MPEG decoder 10 decodes compressed encoded data, such as a MPEG 1 and a MPEG 4, which are transferred with a constant transfer rate through the memory controller 7 or through the MPEG interface 9. The MPEG decoder 10 has a buffer therein for buffering MPEG data. Once a space available in the buffer, the MPEG decoder 10 requests data transferring to the memory controller 7 and downloads the MPEG data of the DRAM 8 to its buffer. The audio-video data decoded by the MPEG decoder 10 are respectively outputted to a user through the LCD display 11 and the speaker 12 visually or auditory.

In other words, reading data from the DRAM 8 by the memory controller 7 and decoding data by the MPEG decoder 10 are not depended on control of the CPU 13 (regardless of the CPU 13 action condition), they are able to perform such operations autonomously.

The battery 3 supplies electric power to activate the audio-video recording and reproducing apparatus 100. The power source controller 4 controls on/off switching to supply power from the battery 3 to the each section under control by the CPU 13.

The SW operation section 5 converts a SW input, such as a reproduction command from a user, into a signal. When the SW controller 6 recognizes that the SW input is triggered by a user, the SW controller 6 supplies an interrupting signal to the CPU 13, and sets contents of the SW input from a user to a dedicated register in the SW controller 6. Just after receiving the interrupting signal, the CPU 13 refers the dedicated register in the SW controller 6, and executes processes in accordance with the SW input by a user. If the interrupting signal is inputted when the CPU 13 is in a low consumption power mode, which will be described later, the CPU 13 refers the special register in the SW controller and executes the process in accordance with the SW input from a user after the CPU 13 is released from the low consumption power mode to a normal action mode (active mode).

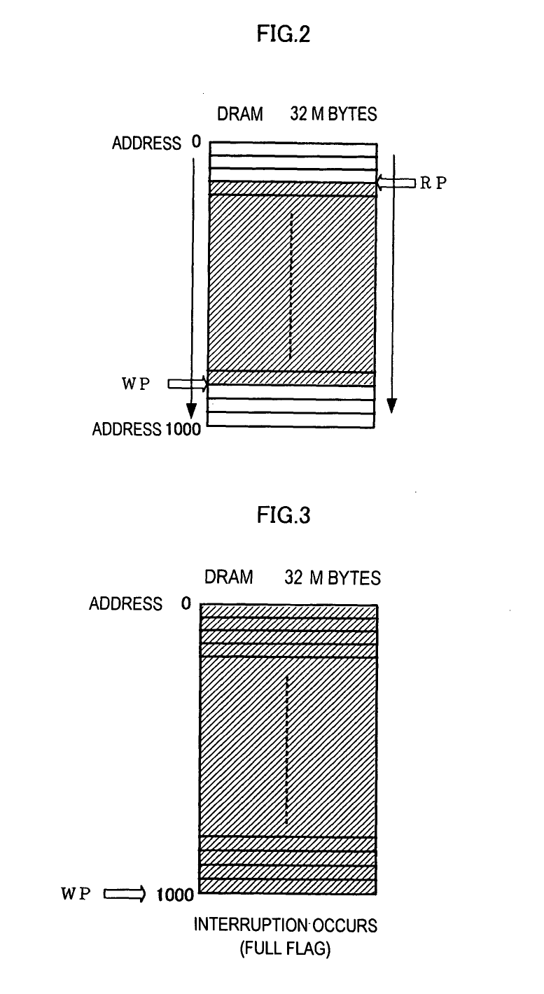

Next, with reference to FIG. 2 to FIG. 4, an address management of the DRAM 8 managed by the memory controller 7 is described.

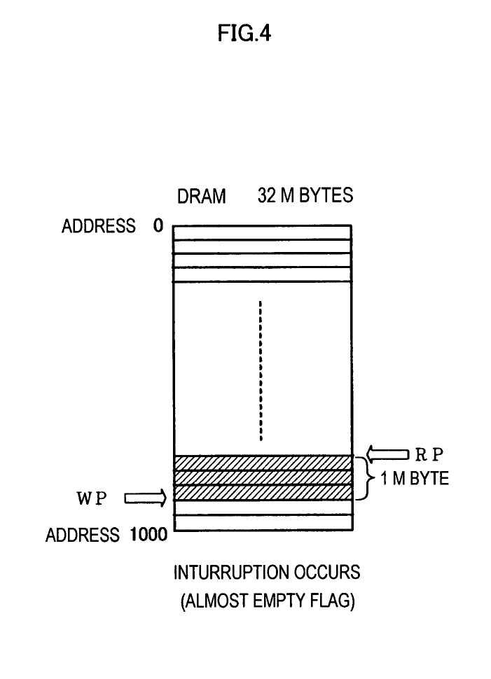

The memory controller 7 carries out the address management of the DRAM 8 with a FIFO action as shown in FIG. 2. A write pointer WP is a value designating a position where data to be written in the DRAM 8, and a read pointer RP is a value designating a position where data to be read in the DRAM 8. In the figure, the shaded portion indicates a region where effective data for reproduction is written. As shown in FIG. 3, when the DRAM 8 becomes full of the effective data for reproduction, the memory controller 7 outputs a full flag as an interrupting signal to the CPU 13 to notify of transfer completion. In addition, as shown in FIG. 4, when residual volume of the effective data for reproduction becomes equal to or less than a threshold level, the memory controller 7 outputs an almost empty flag as the interrupting signal to the CPU 13.

The residual volume of the effective data for reproduction in the DRAM 8 is possible to calculate based on differential between the write pointer WP designating the position the data to be written and the read pointer RP designating the position the data to be read. The threshold level of this data residual volume is determined by a time required for changing mode of the HDD 1 from the low consumption power mode to the active mode, a time required for read retry of the first data and a MPEG decode bit rate. It is,for example, around 1 MB.

Next, the low consumption power mode of the HDD 1 is described as below.

As action modes of the HDD 1, there are a sleep mode that is a low consumption power mode and an active mode that is a normal action mode.

In the sleep mode of the HDD 1, for example, a spindle motor for a media drive of the HDD 1 is stopped, a head is shunted in a ramp section and in an unloading condition. Furthermore, a communication circuit section in the HDD 1 is almost in a non-action condition. In other words, the HDD 1 is virtually in a dormant state.

As methods of releasing the sleep mode, there is a hard reset or a soft reset as below. The hard reset is carried out by making a reset # signal, which is a connector number 1 of ATA, to stay a low level for a certain period. On the other hand, the soft reset is carried out by setting “0” again after “1” is set in a resist bit of the device control register.

The ATA interface 2 is an interface for the CPU 13 and the HDD 1. The CPU 13 can control actions of the HDD 1 by transferring an ATA command to the HDD 1 through the ATA interface 2. The control action to the HDD 1 includes, for example, a change from the active mode to the sleep mode of the HDD1, a release from the sleep mode (or return to the active mode) by the hard reset or the soft reset.

Next, the low consumption power mode of the CPU 13 is described as below.

As the action mode of the CPU 13, there are an active mode that is a normal action mode, a standby mode that is a low consumption power mode, and a sleep mode. Specific condition of the stand-by mode or the sleep mode is depending on a specification of the CPU 13, however it maybe the condition as follows.

In the standby mode of CPU 13, the CPU 13 and a clock pulse generator are stopped together, an internal peripheral module circuit is also not active. A self-refreshment is used to refresh an external memory (SDRAM 8) of the CPU 13. This standby mode can be released by an interrupting signal from outside. When releasing the standby mode, it has to be waited until oscillation of a clock pulse generator becomes stable. Although to release the standby mode takes a time more than to release the sleep mode, because the clock pulse generator action is stopped, the electric power can be saved effectively.

For example, in the sleep mode of the CPU 13, although the CPU 13 is not in active, a clock signal is supplied into the CPU 13 from the clock pulse generator, thus the internal Peripheral module circuit is in. the active condition. An automatic refreshment is used to refresh the external memory (SDRAM 8) of the CPU 13 in the sleep mode. In this sleep mode, because the clock pulse generator is active, more power saving effect cannot be expected than in the standby mode, the time required to recover from the sleep mode is shorter than the time required to recover from the standby mode. The sleep mode can be released by an interrupting signal from outside in the same way as releasing the standby mode. However, since the internal peripheral module circuit is active, the sleep mode is possible to be released by an interrupting signal from the internal peripheral module circuit.

In other words, it can be said that when the CPU 13 is acting in the standby mode or in the sleep mode, which are the low consumption power mode, the CPU 13 is in the dormant state.

Further, in the present embodiment, as the low consumption power mode of the CPU 13, the standby mode is adopted because of having the higher power saving effect, however, the sleep mode may be adopted, of course.

Next, actions of the audio-video recording and reproducing apparatus 100 are described as below.

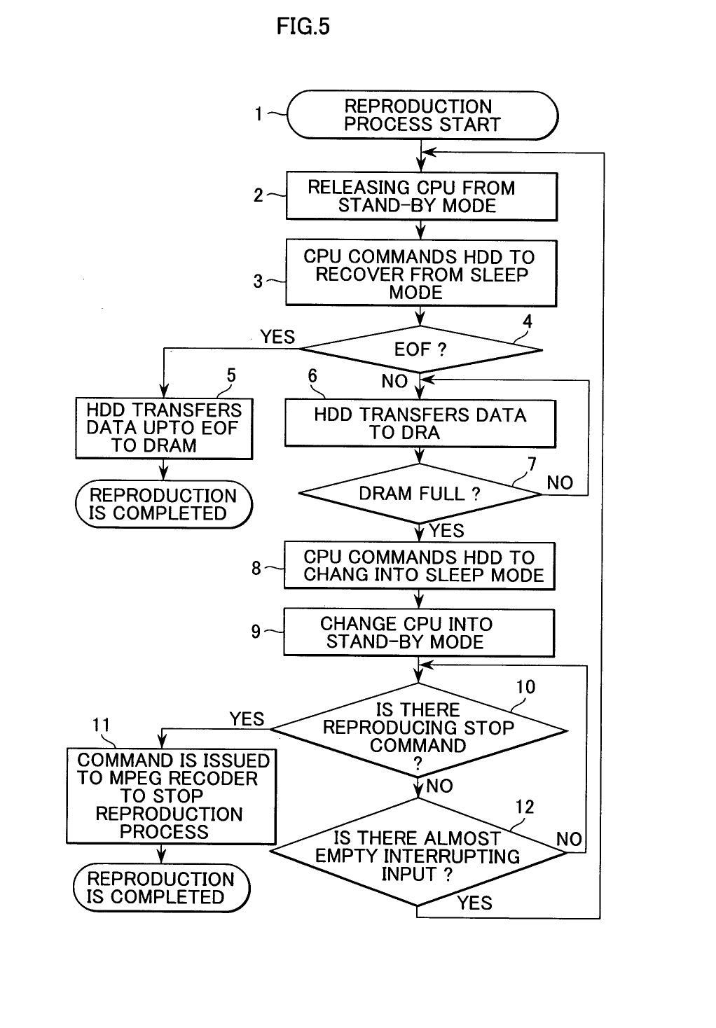

FIG. 5 is a flow chart showing a flow of switching the action modes of the HDD 1 and the CPU 13 during the data reproduction.

As an initial state, the CPU 13 acts in the dormant state that is the standby mode and the HDD 1 acts in the dormant state that is the sleep mode identically.

Step 1

A reproduction request event is occurred by pressing a reproduction button of the SW operating section 5 by a user. The SW controller 6 generates an interrupting signal to the CPU 13 and sets a value of the reproduction request command to the register in the CPU 13.

Step 2

The CPU 13 receives the interrupting signal and releases the standby mode to change to the active mode, and then determines contents of a SW input from a user with reference to the register. When the SW input is the reproduction request command, proceed to step 3.

Step 3

The CPU 13 changes the HDD 1 from the sleep mode to the active mode through the ATA interface 2 in accordance with the reproduction request command. The data read by the HDD 1 through the ATA interface 2 is transferred in units of blocks to the DRAM 8.

Step 4

The CPU 13 determines whether or not an EOF (End of File) code indicating an end of a file is included in the block to be transferred from the HDD 1 to the DRAM 8.

Step 5

When the EOF code is included, the CPU 13 transfers to the DRAM 8 the data up to the EOF code. The data in the DRAM 8 is reproduced until the DRAM 8 becomes empty out, thus the reproduction process is completed.

Step 6

When the EOF code is not included, the CPU 13 transfers the data in units of blocks from the HDD 1 to the DRAM 8.

Step 7

When the DRAM 8 becomes full of its capacity, the memory controller 7 provides a transfer completion signal to the CPU 13.

Step 8

After receiving the transfer completion signal from the memory controller 7, the CPU 13 issues a command to change to the sleep mode through the ATA interface 2 in order to put the HDD 1 into the sleep mode.

Step 9

After ensured the HDD 1 is in the sleep mode, the CPU 13 changes itself into the standby mode.

Step 10

A stop request event occurs by pressing a button of the SW operating section by a user. By this action, the SW controller 6 generates an interrupting signal to the CPU 13 and sets a value of a reproduction stop command to the register in the CPU 13. The CPU 13 reads the reproduction stop command with reference to the register by the interrupting signal.

Step 11

The CPU 13 issues a command to stop reproduction process to the MPEG decoder 10 based on the reproduction stop command, whereby the data reproduction is stopped.

Step 12

When the reproduction stop command does not occur, the CPU 13 continues to reproduce MPEG data.

When the data reproducing is continuing, since the HDD 1 is in the dormant state, volume of the effective data in the DRAM 8 is decreasing by degrees. At the time of the residual volume of the effective data in the DRAM 8 becomes equal to or less than the predetermined threshold level (for example, 1 MB), the memory controller 7 issues an almost empty flag as an interrupting signal to the CPU 13.

After that, return to the step 2, the CPU 13 recovers from the dormant state by releasing the standby mode. Immediate after recovered to the active mode, the CPU 13 changes the HDD 1 from the sleep mode to the active mode, restarts the data transfer from the HDD 1 to the DRAM 8.

As described above, the according to audio-video recording and reproducing apparatus 100 of the present embodiment, the power consumption can totally be reduced by putting the HDD 1 and the CPU 13 into the dormant state intermittently during the period for reproducing the data recorded in the HDD 1.

Following, the saving electric power effect is explained with the specific numerical value.

When a HDD is continuously used in a usual action mode, the power consumption is approximately 693 mW in active idle state (the condition in which a medium is rotating without reading, writing and seeking), in a case of using a HDD with 1.8 inch-diameter (3.3V drive).

On the other hand, in the present embodiment, when assuming that MPEG 4 data of 500 kbps is transferred to the DRAM 8 of 16 MB, the power source of the HDD 1 is made to on and off at about 256 seconds intervals. The consumption power of the HDD 1 of this time is about 70 mW as average because a time for the power source being cut off can be taken long. In addition to this, the power consumption of the DRAM 8 of 16 MB is needed to be considered. Let it be assumed that a general-purpose type DRAM of 3.3V drive is selected as the DRAM 8. As the details of actions with 500 kbps, a periodical read action for filling stream of 500 kbps and a regular auto refresh action are entered under the state in which the pre-charge stand-by state is dominant. Therefore,an average current consumption becomes nearly a pre-charge standby current value 20 mA (66 mW). The total power consumption of the HDD 1 and the DRAM 8 is approximately 136 mW. That is, the power consumption can be reduced to around one-fifth as compared to the same in the active idle states (693 mW).

To express the power consumption effect of the CPU 13 with the specific numerical value is difficult because the power consumption of the CPU 13 is varied under the operating conditions. However, view from the fact that the power consumption of the CPU 13 is falling to several mW in the low consumption power mode as compared to several hundred mW in the normal action mode, it is sure that the power consumption effect is significantly obtained by putting the CPU 13 to operate in the low power consumption mode intermittently during the period for reproducing the data read from the HDD.

It should be noted that, the present invention is not limited to any embodiment described above, it is possible to be changed and excused within the field of technology concept of the present invention appropriately.

For example, in the above embodiment, a mobile type audio-video recording and reproducing apparatus is described, however, the present invention may be applied to a stationary type audio-video recording and reproducing apparatus without the need for battery power. In addition, the present invention may be applied not only to an apparatus specialized to recording and reproduction of audio-video data but also to a general apparatus equipped with a HDD and has functions capable of producing audio-video data read from its HDD. For example, the present invention is also possible to applied to a personal computer.

What is claimed is:

1. An audio-video recording and reproducing apparatus comprising:
a hard disk drive for storing audio and/or video data, which is capable of being one of a dormant state and an active state;
a buffer memory for temporarily storing data read from said hard disk drive;
a system controller for performing at least data transfer from said hard disk drive to said buffer memory and switching control of said state of said hard disk drive, which is capable of being one of a dormant state and an active state;
a reproducing section for reproducing data read from said buffer memory; and
a memory controller having a function for outputting a signal for setting respective states of said hard disk drive and said system controller based on an effective data volume of said buffer memory.

2. The audio-video recording and reproducing apparatus according to claim 1, wherein
said memory controller outputs a signal to said system controller for changing said system controller and said hard disk drive into a dormant state when a data volume of the buffer memory becomes full of its capacity, and outputs a signal to said system controller for releasing said system controller and said hard disk drive from said dormant state when a data volume of said buffer memory becomes equal to or less than threshold level.

3. The audio-video recording and reproducing apparatus according to claim 1, wherein said reproducing section comprises a decoder for decompressing/decoding compressed encoded audio and/or video data.

4. The audio-video recording and reproducing apparatus according to claim 3, said memory controller and said reproduction section have functions to autonomously execute a set of processes starting from the reading of data from said buffer memory to the reproducing of data, and they do not depend on control of said system controller.

5. A method for controlling an audio-video recording and reproducing apparatus comprising the steps of:
transferring audio and/or video data read from a hard disk drive capable of being one of a dormant state and an active state to a buffer memory, under control of a system controller capable of being one of a dormant state and an active state; and
reproducing data read from said buffer memory;
switching respective states of said system controller and said hard disk drive based on an effective data volume of said buffer memory, which is monitored during a data reproduction.

6. The method for controlling the audio-video recording and reproducing apparatus according to claim 5, wherein said system controller and said hard disk drive are changed into a dormant state when a data volume of said buffer memory becomes full of its capacity; and said system controller and said hard disk drive are released from said dormant state when the data volume of said buffer memory becomes equal to or less than a threshold level.
